(19) United States
(12) Patent Application Publication
(10) Pub. No.: US 2010/0103177 A1
(43) Pub. Date: Apr. 29, 2010

(54) GRAPH DISPLAY SYSTEM AND PROGRAM

(76) Inventors: Noboru Shinohara, Tokyo (JP); Masanori Tachikawa, Tokyo (JP); Naohito Doi, Tokyo (JP); Sachiko Nagao, Tokyo (JP); Yoshimori Rikukawa, Tokyo (JP)

Correspondence Address: STAAS & HALSEY LLP, SUITE 700, 1201 NEW YORK AVENUE, N.W., WASHINGTON, DC, 20005, US

(21) Appl. No.: 12/532,724

(22) PCT Filed: Mar. 30, 2007
(86) PCT No.: PCT/JP2007/057071

§ 371 Date: Sep. 23, 2009

(51) Int. Cl. G06T 11/20

(52) U.S. Cl. 345/440

(57) ABSTRACT

Graphs drawn by using economic statistics data are easily and quickly displayed on a display in the form enabling easy recognition and appropriate mutual comparison. Index data 25₁ . . . including graphs drawn by using economic statistics data and attribute information are recorded in a content-by-index storage section (222) of a graph display (2) serving as a Web server. The graph display (2) has a graph display section (211) for allowing a Web browser (131) of a client terminal (1) to display a graph, a call button display section (212) for allowing the Web browser (131) to display an array of graph call buttons associated with the respective displayable graphs, and a graph display change section (213) for changing the graph to the graph associated with the call button according to the command from the client terminal (1).

### BACKGROUND OF THE INVENTION

1. Technical Field

The present invention relates to a technology for displaying economic statistical data, for example, money market data, security exchange data, industry data, commercial data, manufacturing industry data etc., on a computer interface.

2. Background Art

The economic statistical information being formed by statistics corresponding to economic activity concerning fields of money market, security exchange, industry, commerce or manufacturing industry etc. are very important for investors, experts at economy or security exchange, and companies or individual following purchase and offer of securities (i.e. stock, bond etc.), M&A (mergers and acquisitions), investment and financing (hereinafter called ‘investors etc.’), when they judge about investment or offer of financial products. In recent years, the number of individual investors tends to increase, and so the necessity to provide information for accurate judging to various kinds of investors etc. is tending upward. For that reason, the database services collecting and managing the data corresponding to the economic statistical information (hereinafter, called merely ‘economic statistical data’), and provide them to the users by using the internet or other kind of communication network. The users of the database service calculate and/or process the acquired data if necessary, make graphs and/or lists, and use them.

There is a conventional art to download the economic statistical data stored in the database of the server into the database provided in the computer of investor etc., and display them (For example, the patent document 1 described below).

Patent document 1: Japanese laid-open publication No. H10-320469

### DISCLOSURE OF THE INVENTION

### Problems To Be Solved By The Invention

Generally, the economical statistical data contains a large number of items and large quantities of information, and so, in many cases, advances expertise are necessary for extracting user's desired information from the displayed information. However, the art of the patent document 1 only can display one graph on a screen at the same time, so a search button displayed on the upper area of the screen must be clicked when another item of the information is desired to be displayed, and so a large efforts and times are necessary when the user compares and contrasts plural kinds of economic statistical information. Additionally, not only one graph but also plural graphs related each other must be studied when the data are analyzed logically, however it is very difficult to select the related graphs. The invention of the patent document 1 does not have a structure to supply the information necessary for the users to understand the displayed data, and so the invention has a problem that it can only be used by analysts or a part of the investors having advanced expertise.

The present invention is achieved to solve the above-mentioned problems. The purpose of the present invention is to supply a graph display system in which the graphs formed from the economic statistics data can be displayed at a state easy to view and easy to adequately compare, with simple structure and quick motion, that is, a graph display system which can improve usability for many kinds of the investors etc.

### Means for Solving the Problems

(1) For solving the problems described above, the first aspect of the present invention accords to the graph display device connected to a client terminal via a network and makes a display means of the client terminal to display plural graphs generated based on economic statistical data, comprises: a storage means for storing graphs generated based on the economic statistical data and attribute information related to the graph; a graph display means for displaying the graphs stored in the storing means on the specified area of a graph display area; a call button display means for displaying plural graph call buttons, which are related to the individual graphs capable of being displayed on the graph display area and which display graphs on the graph display area, in order on a call button display area provided in the display area; a graph display switch means for inputting a call instruction corresponding to one of the call button from a operation means in the client terminal, and switching the displayed graph on the graph display area to the graph related to the call button corresponding to the input call instruction.

(2) According to the graph display system relating to (1); the storage means stores the topic info indication, which is generated according to kind etc. of information indicated by the individual graphs, as attribute information of the related graph; the call button display means displays the topic information related to the individual graph on the corresponding call button of the call button display area; the graph display switch means switches the displayed graph on the graph display area to the graph corresponding to a call instruction, by using the attributed information related to the call button corresponding to the call instruction.

(3) According to the graph display system relating to (2); the call instruction corresponding to the call button is a mouse over against the call button displayed on the display means, performed by operating the operation means of the client terminal.

(4) According to the graph display system relating to either one of (1) to (3); when the instruction to continue the graph displaying is input from the operation means of the client terminal, the graph display means continues displaying of the graph corresponding to the instruction.

(5) According to the graph display system relating to either one of (1) to (4); the graph display means displays plural graphs being related each other in advance on the graph display area simultaneously.

(6) According to the graph display system relating to either one of (1) to (5); the graph display means generates the graph in which coordinate of horizontal axis is time information, and; the graph display means displays the graphs in which each of the graphs displayed at the same position has the horizontal axis of substantially the same coordinate and substantially the same position.

(7) According to the graph display system relating to either one of (1) to (6); the graph display means displays the graphs in which each of the graphs displayed at the same position has the vertical axis of substantially the same position and substantially the same length.

(8) According to the graph display system relating to either one of (2) to (7); the graph display system comprises a storage means for storing a category information which contains the topic information and is related to the corresponding graph as the attribute information; a category information display means for displaying a category display area containing the graph display area and the topic display area on the display area of the client terminal; a category display switch means for switching the displayed category information on the category display area to the category information corresponding to an instruction, when the instruction corresponding to one of the category information is input from the operation means of the client terminal.

(9) According to the graph display system relating to either one of (1) to (8); the graph display system comprises a detailed information display means for displaying detailed information, which indicates detailed information of the graph stored in the storage means and is related to the corresponding graph, on the display means of the client terminal based on an instruction from the operation means of the client terminal.

(10) For solving the problems described above, the second aspect of the present invention accords to the program for making a computer to work as the graph display system according to either one of (1) to (9).

### EFFECTS OF THE INVENTION

The present invention according to (1) comprises the storage means storing the graph generated based on the economic statistical data and the attribute information of the stored graph, so the economic statistical data can be supplied to the client terminal as graph information easy to understand visually. Moreover, the present invention comprises the graph display system having the graph display means for displaying the graphs stored in the storage means on the specified position of the graph display area, so the graph based on the economic statistical data can be displayed by the client terminal. Furthermore, the present invention comprises the call button display means for displaying the call buttons, which is used for displaying the graphs on the graph display area, on the call button display area provided in the display area of the client terminal in order, so the present invention can select the desired graph form plural graphs quickly and appropriately, and display it. In addition, the switched graph is always displayed on the specified area in the graph display area, so the graphs can be compared easily in a visual and feeling manner. Additionally, the present invention can display only the necessary graphs on the graph display area, so the graphs can be displayed on the display means in a condition easy to view even if compared graphs are many. As a result, the present invention can display easily and quickly the graphs generated in connection with the economic statistical data in the condition easy to view and easy to compare appropriately, so the usability for many kinds of investors etc. can be improved.

According to the present invention of (2), the storage means stores the topic information generated according to kind etc. of information indicated by the individual graphs and being related to the corresponding graph as attribute information, the call button display means displays the topic information related to the individual graphs when the call button is operated, the graph display switch means switches the displayed graph on the graph display area to a graph corresponding to a call instruction, by using the attribute information related to the call button corresponding to the call instruction. Therefore, the investors etc. using the client terminal can make each of the call buttons to display the topic information closely related to the meanings and contents of the graph, and make the graph to be displayed on the graph display area while viewing the displayed topic information. As a result, the graph can be selected more quickly and easily, and so the usability for many kinds of investors etc. can be improved.

According to the present invention of (3), the operation of the operation means for performing the call instruction to the call button is a mouse over toward the call button displayed on the display means, so the graph can be switched quickly by performing a mouse over by the mouse cursor toward the call button located in order. In addition, the graphs displayed on the display means can be switched continuously and speedily by continuously performing mouse over of the mouse cursor toward the plural call buttons. As a result, the graph can be selected more quickly and easily, and so the usability for many kinds of investors etc. can be improved.

According to the present invention of (4), the graph display means continues the graph displaying based on the instruction input from the operation means of the client terminal. Therefore, the present invention can keep the displaying of graph in the case where keeping of the graph displaying is necessary, and so the usability for many kinds of investors etc. can be improved.

According to the present invention of (5), the graph display means can simultaneously display plural graphs being related each other in advance, so the closely related graphs can be displayed simultaneously on single graph display area. As a result, the closely related graphs can be compared easily, and so the usability for many kinds of investors etc. can be improved.

According to the present invention of (6), the graph display means generates a graph in which the horizontal axis indicates time information, and the graph display means displays the graphs in which each of the graphs displayed at the same position has the horizontal axis of substantially the same coordinate and substantially the same position. Therefore, the graph display area can effectively unify the coordinates and displayed positions of time axis between the graphs corresponding to the economic statistical data of time series. As a result, it is easy for the users to visually compare the information of the graphs, because all of time information of the graphs are unified. Consequently, the present invention can makes it easier to compare the graphs in a visual and feeling manner, and so the usability for many kinds of investors etc. can be improved.

According to the present invention of (7), the graph display means makes the graph display area to display graphs in which each of the graphs displayed at the same position has the vertical axis of substantially the same position and substantially the same length. As a result, the present invention can make the height of the graphs substantially the same between all graphs of the same position. Consequently, the present invention can makes it easier to compare the graphs in a visual and feeling manner, and so the usability for many kinds of investors etc. can be improved.

According to the present invention of (8), the storage means stores the category information, each of which relates to plural topic information containing the graphs and attribute information. Moreover, the present invention comprises the category information display means making the display area of the client terminal to display the category display area containing the graph display area and the topic display area. Furthermore, the present invention comprises the category display switch means switching the displayed category information on the category display area to the category information corresponding to an instruction, which is input from the operation means of the client terminal, to display the specified category information. Consequently, the present invention can make the client terminal to display the graphs under the state that the graphs are divided into plural groups based on the meanings and contents of the graphs. Moreover, the investors etc. can search their desired information by using the category information that is closely related to the meanings and contents of the graphs. Therefore, the users can select the graphs more quickly and easily, and so the usability for many kinds of investors etc. can be improved. In addition, the users can put the complex economic statistical data in order by categories and topics of the financial products, can easily acquire the information necessary for making decision about investment, and can make appropriate decision.

According to the present invention of (9), the detailed information display means makes the display means of the client terminal to display the detailed information that are related to the graphs and indicate the detailed information of the graphs stored in the storage means. Therefore, the investors etc. can grasp the detail of information of the graphs and related information easily, and can decide whether investment should be executed or not. Therefore, the usability for many kinds of investors etc. can be improved.

According to the present invention of (10), the graph display system of the present invention can be achieved on many kinds of computers by performing programs.

### BRIEF DESCRIPTION OF THE DRAWINGS

FIG. 1 is a functional block diagram showing the system structure of the graph display system according to an embodiment of the invention.

FIG. 2 is a conceptual diagram showing a data structure of the index data stored into the graph display system of the embodiment.

FIG. 3 is a conceptual diagram showing a menu contents screen (that is, an initial screen of the graph display system) of the embodiment.

FIG. 4A is a flowchart showing the procedures for switching the display of the initial screen when the ‘GENERAL ECONOMY’ is selected among the categories. FIG. 4B is a flowchart showing the procedures for switching the displaying from the initial screen when the ‘STOCK AND INDUSTRY’ is selected among the categories. FIG. 4C is a flowchart showing the procedures for switching the displaying from the initial screen when the ‘INTEREST AND EXCHANGE’ is selected among the categories. FIG. 4D is a flowchart showing the procedures for switching the displaying from the initial screen when the ‘PRODUCTS AND REAL PROPERTY’ is selected among the categories.

FIG. 5 is a flowchart showing the procedures of the initial processing for displaying the screen of the selected category.

FIG. 6 is a conceptual diagram showing the screen of the selected category on a Web browser.

FIG. 7A is a flowchart showing procedures when a cursor moves on the call buttons displayed on the screen of the selected category. FIG. 7B is a flowchart showing procedures when the call button displayed on the screen of the selected category is clicked by using the cursor.

FIG. 8 is a conceptual diagram showing the screen of the selected category on a Web browser.

FIG. 9A is a flowchart showing the procedures for displaying the simple explanation information on the graph display area. FIG. 9B is a flowchart showing the procedures when a mouse cursor leaves from the graph on which the simple explanation information is displayed. FIG. 9C is a flowchart showing the procedures when a plotted area of the displayed graph is clicked.

FIG. 10 is a conceptual diagram showing a graph display area of a Web browser on which the simple explanation information is displayed.

FIG. 11 is a conceptual diagram showing the detailed information displayed on the Web browser.

### DESCRIPTION OF THE PREFERRED EMBODIMENTS

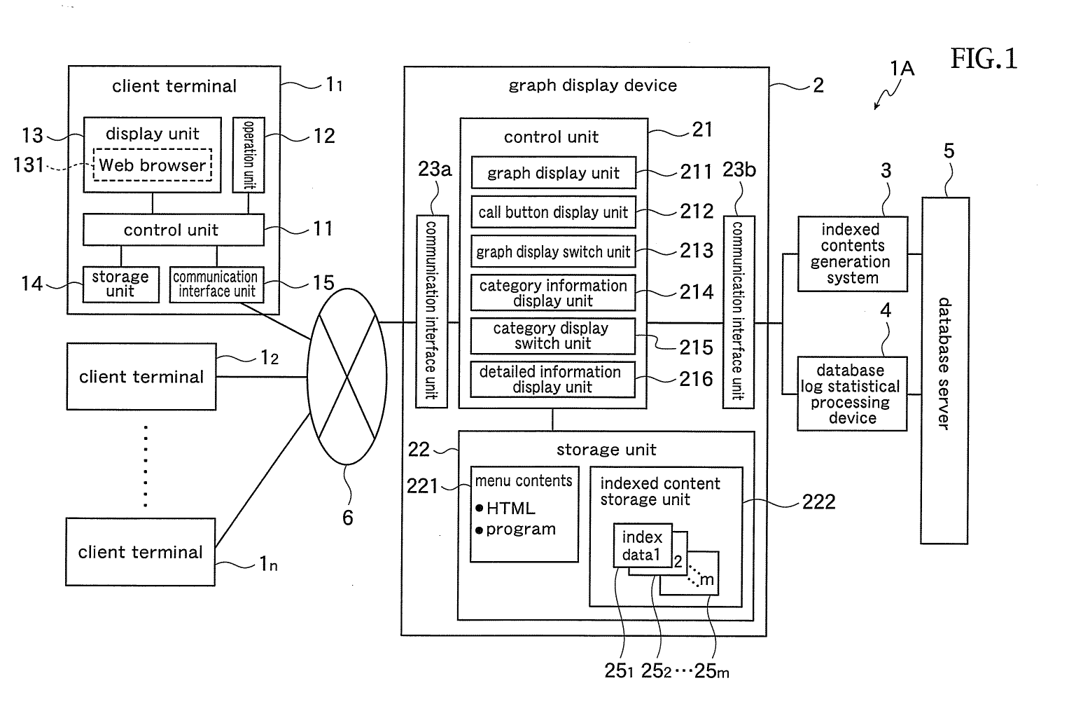

Hereinafter, an embodiment of the present invention is described with referencing FIGS. 1 to 11.

### First Embodiment

FIG. 1 is a functional block diagram showing the system structure of the graph display system according to an embodiment of the invention. As shown in FIG. 1, the graph display system 1A is a client server system, and comprises client terminals 1₁, 1₂, . . . 1ₙ (n is larger than 1) at the client side, and comprises a graph display device 2, an indexed content generation device 3, a database log statistical processing device 4 and a database server 5 at the server side. A graph display device 2, an indexed content generation device 3, a database log statistical processing device 4 and a database server 5 are connected each other by using interface devices which are not shown in FIG. 1, furthermore, the client terminals 1₁, 1₂, . . . 1ₙ and the graph display device 2 are connected to the internet 6. Incidentally, the client terminals 1₁, 1₂, . . . 1ₙ have the same structure, and so called ‘client terminal 1’ hereinafter for making the description simpler, except for the case that the distinction of the client terminals 1₁, 1₂, . . . 1ₙ is necessary.

The client terminal 1 is a computer that can connect to a communication network, for example, a personal computer, a workstation or a mobile telephone. The client terminal 1 comprises a control unit 11, an operation unit 12 as the ‘operation means’, a display unit 13 as the ‘display means’, a storage unit 14 and a communication interface (I/F) unit 15. Incidentally, each of the client terminals 1₂, . . . 1ₙ has the same structure as the client terminal 1₁, though FIG. 1 does not show.

The control unit 11 comprises a CPU (Central Processing Unit), and controls the whole processing of client terminal 1 by performing calculating and processing of OS (Operating System) program in the storage unit 14 and various kinds of application programs.

The operation unit 12 is a mouse, a keyboard or other kind of input device that is used for inputting various kinds of instructions. The display unit 13 comprises a LCD (Liquid Crystal Display) or other kind of display device that displays the various kinds of instructions input by using the operation unit 12 and various kinds of pictures. The display unit 13 displays screens of a Web browser 131 that displays the pictures corresponding to the information sent from the server by using HTTP (Hyper Text Transfer Protocol) communication.

The storage unit 14 comprises a ROM into which loading program etc. are stored in advance, a RAM which temporarily stores programs and data and works as a working area of the control unit 11 (namely the CPU), an EEPROM which stores data necessary for rewriting, a hard disk which stores various kinds of file data etc. The OS program and plural kinds of application programs are stored into the hard disk.

The communication interface unit 15 comprises a UTP cable port or optical cable port, and one or more kinds of device drivers. The communication interface unit 15 is connected to a LAN cable or an optical cable, and performs processing necessary for the data communication with the graph display device 2.

Incidentally, the graph display device 2 is a Web server and comprises a control unit 21 having the same structure as the control unit 11 of the client terminal 1, a storage unit 22 having the same structure as the storage unit 14 of the client terminal 1, and the communication interface units 23a and 23b having the same structure as the communication interface unit 15.

The control unit 21 forms a graph display unit 211 as the ‘graph display means’, a call button display unit 212 as the ‘call button display means’, a graph display switch unit 213 as the ‘graph display switch means’, a category information display unit 214 as the ‘category information display means’, a category display switch unit 215 as the ‘category display switch means’ and a detailed information display unit 215 as the ‘detailed information display means’ by using an application program contained in the menu contents (described below) stored in the storage unit 22 or other technologies for realizing these functions.

The graph display unit 211 makes the graphs in the index data (described below) stored in the indexed content storage unit of the storage unit 22 to be displayed on the specified position of the graph display area (described below) provided in the display unit 13 of a client terminal 1.

The call button display unit 212 displays call buttons in order, each of which corresponds to the graphs being able to be displayed by the graph display unit 211, on the call button display area (described below) provided in the display area of the client terminal 1.

The graph display switch unit 213 switches the displayed graph on the graph display area to the graph corresponding to one of the call button (described below) operated by using the operation unit 12 of the client terminal 1.

The category information display unit 214 makes the display area (described below) of the client terminal 1 to display the category display area containing the graph display area (described below) and the topic display area (described below).

The category display switch unit 215 switches the displayed category information on the category display area (described below) to the category information corresponding to the display instruction input from the operation unit 12 of the client terminal 1.

The detailed information display unit 216 makes the display unit 13 of the client terminal 1 to display the detailed information corresponding to the instruction input from the operation unit 12 of the client terminal 1.

Incidentally, a part of the functions of the graph display unit 211, the call button display unit 212, the graph display switch unit 213, the category information display unit 214, the category display switch unit 215 and the detailed display unit 216 can be realized by the client terminal 1.

The storage unit 22 stores the menu contents 221 and comprises the indexed contents storage unit 222 as the “storage means”.

The menu contents 221 contains the data of HTML format and the programs, and is used for making the Web browser 131 of the client terminal 1 to form the screen structure and to display various kinds of data. The graph display unit 211, the call button display unit 212, the graph display switch unit 213, the category information display unit 214, the category display switch unit 215 and the detailed display unit 216, which are means for realizing the above described functions, are formed by using these programs and so forth.

The indexed contents storage unit 222 stores plural index data 25₁, 25₂, . . . , 25ₘ (m is larger than 1), each of which is used for making the client terminal 1 to display the data. Incidentally, the index data 25₁, 25₂, . . . 25ₘ have the same data structure, and so called ‘index data 25’ hereinafter for making the description simpler, except for the case that the distinction of the index data 25₁, 25₂, . . . 25ₘ is necessary.

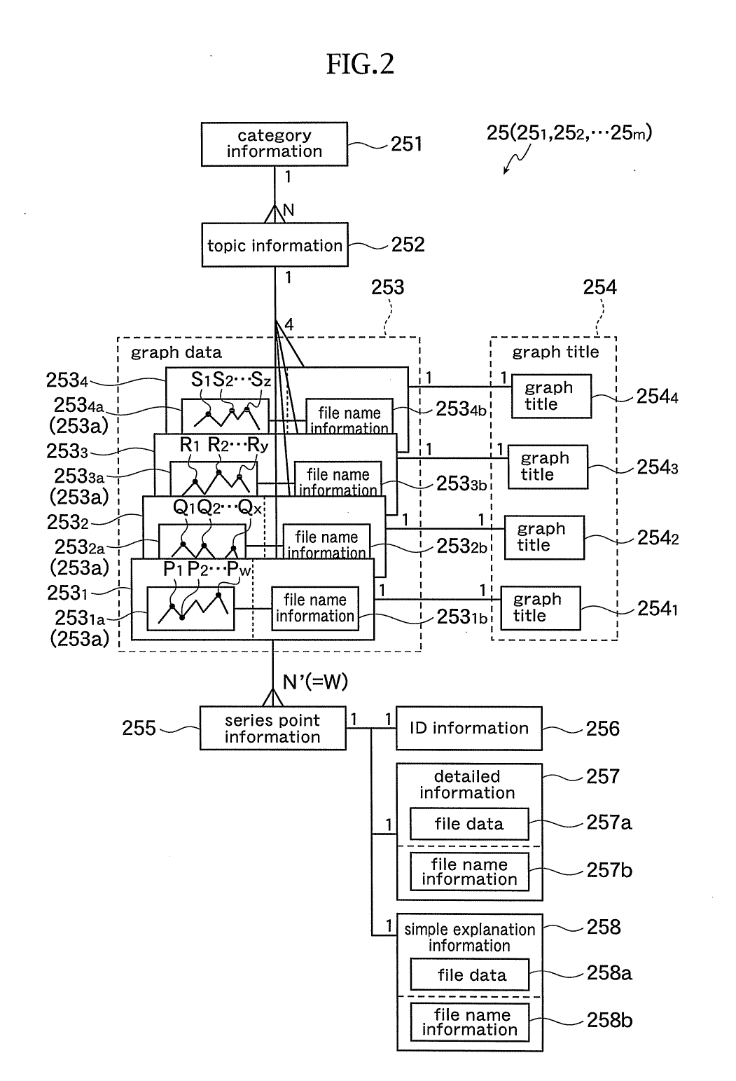

FIG. 2 is a conceptual diagram showing a data structure of the index data. As shown in FIG. 2, each of the index data 25 contains the category information 251, the topic information 252, the graph data 253, the graph titles 254, the series point information 255, the ID information 256, the detailed information 257 and the simple explanation information 258. The graph data 253 contains a first graph data 253₁, a second graph data 253₂, a third graph data 253₃ and a fourth graph data 253₄, and the graph titles 254 contains a first graph title 254₁, a second graph title 254₂, a third graph title 254₃ and a fourth graph title 254₄. Each category information 251 of the index data 25 is related to plural topic information 252, and each of the topic information 252 is related to one first graph data 253₁, one second graph data 253₂, one third graph data 253₃ and one fourth graph data 253₄. Each of the graph data 253₁ to 253₄ is related to one of graph titles 254₁ to 254₄. Each of the graph data 253, for example the first graph data 253₁, is related to plural number of the series point information 255 (explanation according to the number of the series point information 255 is described below). Each of the series point information 255 is related to one of ID information 256, one of detailed information 257 and one of simple explanation information 258. The category information 251, the topic information 252, the detailed information 257 and simple explanation information 258 are respectively the attribute information of a first graph, a second graph, a third graph or a fourth graph (all of their graphs are described below) contained in each of graph data 253₁ to 253₄. Incidentally, the second graph data 253₂, the third graph data 253₃ and the fourth graph data 253₄ are respectively related to one of series point information 255 as well as the first graph data 253₁, though not shown in FIG. 2.

The category information 251 is the information of the highest rank in the hierarchy of the economic statistical data processed by the graph display device 2. The present embodiment contains ‘GENERAL ECONOMY’, ‘STOCK AND INDUSTRY’, ‘INTEREST AND EXCHANGE’ and ‘PRODUCTS AND REAL PROPERTY’ as the categories.

The topic information 252 is the information of the second rank from the top of the hierarchy. Each of the topic information 252 corresponds to one of the category information 251.

Each of the first to fourth graph data 253₁ to 253₄ contains image data corresponding to a graph and file name information which specify the names of the file used in the indexed contents storage unit 222. For example, the first graph data 253₁ contains the first graph 253₁ₐ that is an image data for displaying a graph, and the first file name information 253_{1b} that is the name of the first graph 253₁ₐ. The first graph 253₁ₐ corresponds to one of four items belonging to one economic statistics data, for example, the stock price, the interest, the manager's mind or the business activity of the specified business. Similarly, the second graph data 253₂ contains the second graph 253₂ₐ similar to the first graph 253₁ₐ and the second file name information 253_{2b} that is the name of the second graph 253₂ₐ, the third graph data 253₃ contains the third graph 253₃ₐ similar to the first graph 253₁ₐ and the third file name information 253_{3b} that is the name of the third graph 253₃ₐ, the fourth graph data 253₄ contains the fourth graph 253₄ₐ similar to the first graph 253₁ₐ and the fourth file name information 253_{4b} that is the name of the fourth graph 253₄ₐ. Incidentally, the first to fourth file name information 253_{1b} to 253_{4b} contains the address information that indicates the physical location into which the first to fourth graph 253₁ₐ to 253₄ₐ are stored.

The first graph 253₁ₐ, the second graph 253₂ₐ, the third graph 253₃ₐ and the fourth graph 253₄ₐ have plural points which are plotted for specifying the series of graphs and plotted for specifying the point in time or other values of the data on the line graph, the bar chart or other kind of graph. In the present embodiment, the first graph 253₁ₐ has points of W (W is more than or equal to 1), that is, P₁, P₂, . . . P_{W}, the second graph 253₂ₐ has points of X (X is more than or equal to 1), that is, Q₁, Q₂, . . . Q_{X}, the third graph 253₃ₐ has points of Y (Y is more than or equal to 1), that is, R₁, R₂, . . . R_{Y} and the fourth graph 253₄ₐ has points of Z (Z is more than or equal to 1), that is, S₁, S₂, . . . S_{Z}.

The first to fourth graph titles 254₁ to 254₄ are text data indicating the titles of the first to fourth graph 253₁ₐ to 253₄ₐ.

The series point information 255 is the data indicating the series of graphs that are minimum unit of data group in the economic statistical data of the present embodiment. Hereinafter the series of graphs is called merely ‘series’. The number of series is N′ (N′ is more than or equal to 1). In other words, N′ is corresponding to point number of one of the first to fourth graphs 253₁ₐ to 253₄ₐ, that is, P₁, . . . P_{W}, Q₁, . . . Q_{X}, R₁, . . . R_{Y} or S₁, . . . S_{Z}. For example, as shown in FIG. 2, the first graph data 253₁ is related to the series point information 255 of W that is the same as the number of points P₁, . . . P_{W} of the first graph 253₁ₐ. Similarly, the second graph data 253₂ is related to the series point information 255 of X that is the same as the number of points Q₁, . . . Q_{X} of the second graph 253₂ₐ, the third graph data 253₃ is related to the series point information 255 of Y that is the same as the number of points R₁, . . . R_{Y} of third graph 253₃ₐ, the fourth graph data 253₄ is related to the series point information 255 of Z that is the same as the number of points S₁, . . . S_{Z} of the fourth graph 253₄ₐ, although not shown in FIG. 2.

Each of these series point information 255 is depended to one of ID information 256, one of detailed information 257 and one of simple explanation information 258.

The ID information 256 is an information for specifying one of the series point information 255.

The detailed information 257 is a text data or an image data indicating the detailed information corresponding to the individual point of P₁, . . . P_{W}, Q₁, . . . Q_{X}, R₁, . . . R_{Y} or S₁, . . . S_{Z}. For example, the information provided from the line graph or the bar chart, and the tendency of the line graph can be employed as the detailed information 257. The detailed information 257 comprises a file data 257a containing the content of information and a file name information 257b containing the file name of the file data 257a. Incidentally, the file name information 257b contains the address information that indicates the physical location of the indexed contents storage unit 222 into which the file data 257a is stored.

The simple explanation information 258 is a simple text data indicating the summary of information corresponding to the individual point of P₁, . . . P_{W}, Q₁, . . . Q_{X}, R₁, . . . R_{Y} or S₁, . . . S_{Z}. The simple explanation information 258 comprises a file data 258a containing the text data and a file name information 258b containing the file name of the file data 258a. Incidentally, the file name information 258b contains the address information that indicates the physical location of the indexed contents storage unit 222 into which the file data 258a is stored.

As described above, the indexed contents storage unit 222 stores plural index data 25 of such structure. The number of index data 25 is equal to the number of the category information 251.

Incidentally, the first to fourth graph data 253₁ to 253₄, the first to fourth graphs 253₁ₐ to 253₄ₐ, the first to fourth file name information 253_{1b} to 253_{4b} and the points P₁, . . . P_{W}, Q₁, . . . Q_{X}, R₁, . . . R_{Y} or S₁, . . . S_{Z} have basically the same structure each other, and so called the graph data 253, the graph 253ₐ, the file name information 253_{b}, the point P, the point Q, the point R and the point S, except for the case that the distinctions of them are necessary.

As shown in FIG. 1, the database server 5 stores a large quantity of the economic statistical data. The index data 25 are generated based on the economic statistical data stored in the database server 5. The database log statistical processing system 4 automatically extracts the data, which satisfies the predetermined condition for being used for generating the index data 25, from the economic statistical data stored in the database server 5, and sends the information of the extracted data to the graph display device 2. The indexed contents generation system 3 generates new index data 25 and renews the previously generated index data 25 at the time when the economic statistical data stored in the database server 5 is published. The results of the renewals are sent to the graph display device 2. The graph display device 2 stores the received data into the indexed contents storage unit 222.

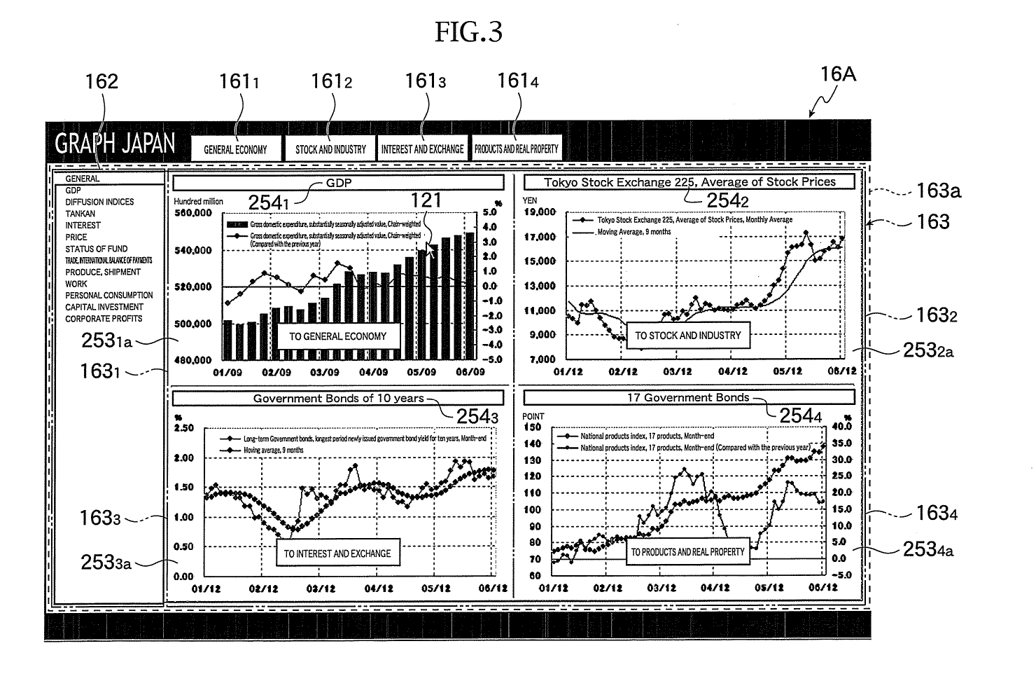

FIG. 3 through FIG. 11 are flowcharts showing the procedures of processing executed in the graph display system of the present embodiment and the conceptual diagrams showing the screen made by the procedures in accordance with the flowcharts. Hereinafter, the processing of the graph display system 1A, specifically the processing of the graph display device 2, is described.

### <Displaying of the Initial Screen>

Firstly, the user of the client terminal 1 makes the display unit 13 to display the Web browser 131, and access to the graph display device 2. The graph display unit 211, the call button display unit 212 and the category information display unit 214 of the graph display device 2 send the data and the programs corresponding to the menu contents screen stored as the menu contents 221, by using the HTTP communication. Thereafter the graph display unit 211 makes the Web browser 131 to display the menu contents screen 16A as the initial screen. The menu contents screen 16A is the initial screen for the user of the client terminal 1 to search and view the detailed economic statistical data.

FIG. 3 is a conceptual diagram showing a menu contents screen. As shown in FIG. 3, four category tabs 161₁, 161₂, 161₃ and 161₄ are arranged in a row near the top end of the menu contents screen 16A. The category tabs 161₁, 161₂, 161₃ and 161₄ are displayed under the control of the category information unit 214, and are used for selecting user's desired category display area. The category tabs 161₁, 161₂, 161₃ and 161₄ are formed corresponding to the category information 251 in the index data 25, and so ‘GENERAL ECONOMY’, ‘STOCK AND INDUSTRY’, ‘INTEREST AND EXCHANGE’ and ‘PRODUCTS AND REAL PROPERTY’ are displayed on the tabs. The category display area 163a is displayed under the category tabs 161₁, 161₂, 161₃ and 161₄.

On the left part of the category display area 163a, the call button display area 162, which is corresponding to the ‘topic display area’ of the present invention, is displayed under the control of the call button display unit 212.

On the right part of the category display area 163a, the graph display area 163 is displayed under the control of the graph display unit 211. The graph display area 163 is further divided into four small areas for displaying single graph individually, that is, the first graph display area 161₁ of upper-left, the second graph display area 161₂ of upper-right, the third graph display area 163₃ of lower-left and the fourth graph display area 161₄ of lower-right. As described below, the graph display areas 163₁ to 161₄ individually display the first to fourth graphs 253₁ₐ to 253₄ₐ contained in the first to fourth graph data 253₁ to 253₄ of the index data 25. The graph titles 254₁ to 254₄ of the index data 25 are displayed on the upper side of each of the graph display areas 161₁ to 161₄.

When the user of the client terminal 1 clicks one of category tabs 161₁, 161₂, 161₃ and 161₄ by using mouse 121 (i.e. the operation unit 12), the category display switch unit 215 switches the menu contents screen 16A to the screen of the selected category, so the category display area 163a displayed on the menu contents screen 16A is replaced to the category display area 163a instructed by the user.

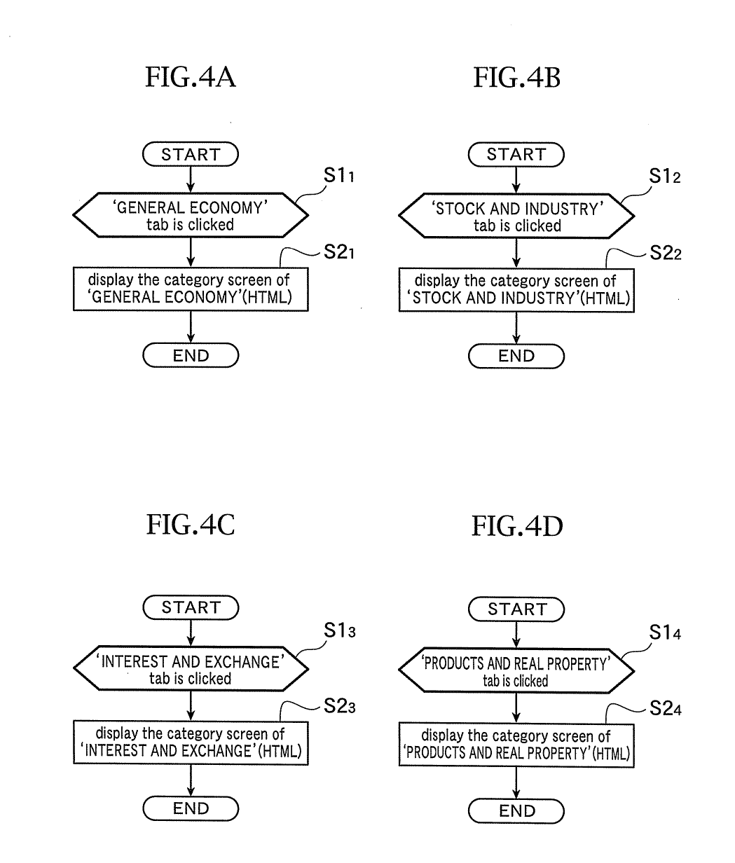

Concretely, as shown in the flowchart of FIG. 4A, when the ‘GENERAL ECONOMY’ tab 161₁ is clicked (see step S1₁), the category display switch unit 215 and the category display unit 214 acquire the index data 25 containing the category information 251 corresponding to the ‘GENERAL ECONOMY’, make the Web browser 131 to display the screen corresponding to the ‘GENERAL ECONOMY’ (not shown), and make the screen (not shown) to display the acquired index data 25 (see step S2₁).

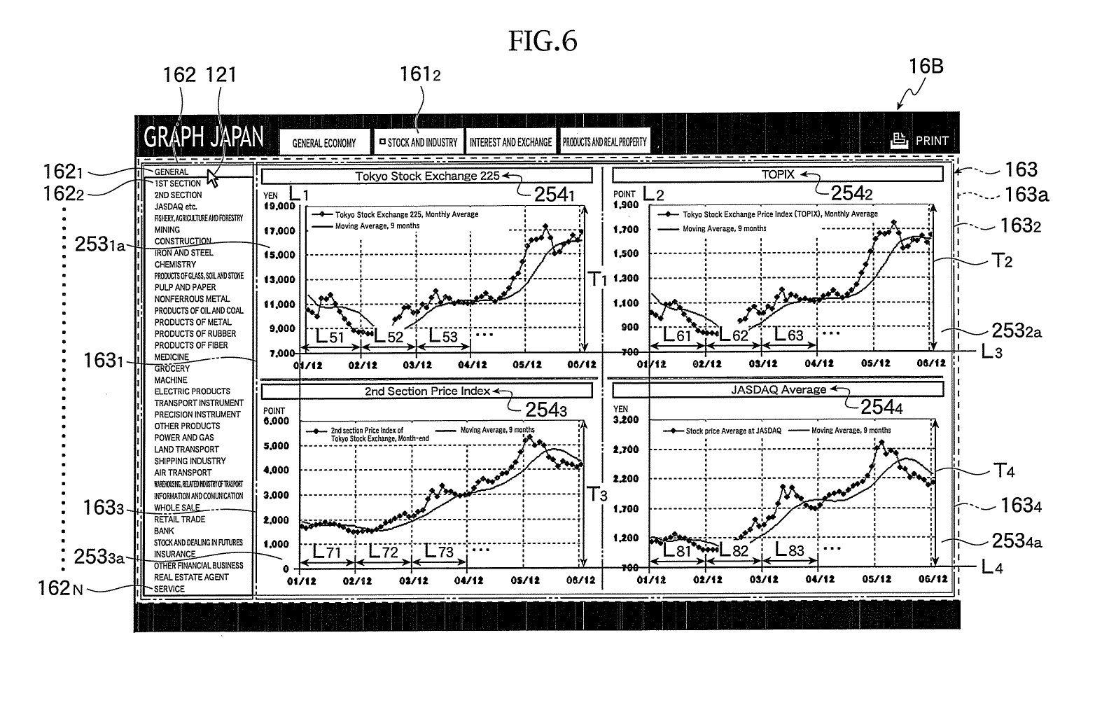

Similarly, as shown in the flowchart of FIG. 4B, when the ‘STOCK AND INDUSTRY’ tab 161₂ is clicked (see step S1₂), the category display switch unit 215 and the category display unit 214 acquire the index data 25 containing the category information 251 corresponding to the ‘STOCK AND INDUSTRY’ from the indexed storage unit 222, make the Web browser 131 to display the screen 16B corresponding to the ‘STOCK AND INDUSTRY’ shown in FIG. 6, and make the screen to display the acquired index data 25 (see step S2₂). As shown in the flowchart of FIG. 4C, when the ‘INTEREST AND EXCHANGE’ tab 161₃ is clicked (see step S1₃), the category display switch unit 215 and the category display unit 214 acquire the index data 25 containing the category information 251 corresponding to the ‘INTEREST AND EXCHANGE’ from the indexed content storage unit 222, make the Web browser 131 to display the screen corresponding to the ‘INTEREST AND EXCHANGE’ (not shown), and make the screen (not shown) to display the acquired index data 25 (see step S2₃). Moreover, As shown in the flowchart of FIG. 4D, when the ‘PRODUCTS AND REAL PROPERTY’ tab 161₄ is clicked (see step S1₄), the category display switch unit 215 and the category display unit 214 acquire the index data 25 containing the category information 251 corresponding to the ‘PRODUCTS AND REAL PROPERTY’ from the indexed content storage unit 222, make the Web browser 131 to display the screen corresponding to the ‘PRODUCTS AND REAL PROPERTY’ (not shown), and make the screen (not shown) to display the acquired index data 25 (see step S24).

Incidentally, the screen corresponding to the ‘GENERAL ECONOMY’ (not shown), the screen corresponding to the ‘INTEREST AND EXCHANGE’ (not shown) and the screen corresponding to the ‘PRODUCTS AND REAL PROPERTY’ (not shown) have screen structures similar to the screen 16B corresponding to the ‘STOCK AND INDUSTRY’, which is shown in FIG. 6 as a conceptual diagram, and are controlled in the same way as the screen 16B. Therefore, only the procedures when the screen 16B corresponding to the ‘STOCK AND INDUSTRY’ is displayed on the Web browser 131 (see step S22) are described hereinafter.

### <Initial Processing for the Menu Contents Screen of the Selected Category>

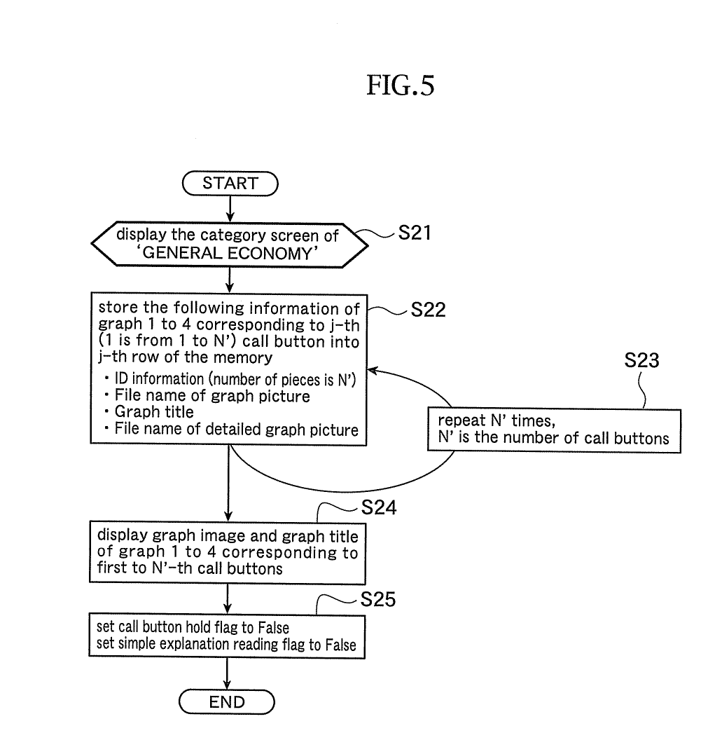

FIG. 5 is a flowchart showing the procedures of the initial processing for displaying the screen 16B corresponding to the selected category. As shown in FIG. 5, when the ‘STOCK AND INDUSTRY’ tab 161₂ displayed on the menu contents screen 16A of the Web browser 131 in the client terminal 1 is clicked (see step S21), the graph display unit 211 acquires the index data 25 containing the category information 251 of ‘STOCK AND INDUSTRY’ from the indexed contents storage unit 222. Moreover, the graph display unit 211 stores the setting information corresponding to the first topic information 252, which is (1) to (4) described below, into the predetermined row (not shown) of the random access memory (RAM) provided in the storage unit 14. The first topic information may be stored into the first row of the RAM, and may be stored into the j-th (‘j’ is equal to or more than 1, and equal to or less than N) row of the RAM.

(1) N′ units of the ID information 256 which are related to the first to fourth graph data 253₁ to 253₄ of the first topic information 252, via the series point information 255
(2) The first to fourth file name information 253_{1b} to 253_{4b} contained in the first to fourth graph data 253₁ to 253₄ that correspond to the first topic information 252
(3) The graph titles 254₁ to 254₄ that correspond to the first topic information 252
(4) The file name information 257b of the detailed information 257 that correspond to the first topic information 252

The setting process (1) through (4) described above are repeated the same frequency as the number of the topic information 252 being related to the index data 25 (i.e. ‘N’, see step S23).

After the completion of all settings, the graph display unit 211 makes the Web browser 131 of client terminal 1 to display the screen corresponding to the category ‘STOCK AND INDUSTRY’ (see step S24).

FIG. 6 is a conceptual diagram showing the screen 16B of the selected category displayed on the Web browser 131. As shown in FIG. 6, four category tabs 161₁, 161₂, 161₃ and 161₄ are displayed in a horizontal row near the top end of the screen 16B, the category display area 163a is displayed under the category tabs 161₁, 161₂, 161₃ and 161₄, the call button display area 162 is displayed in the left part of the category display area 163a and the graph display area 163 is displayed in the right part of the category display area 163a, similar to the menu contents screen 16A.

Among four category tabs 161₁, 161₂, 161₃ and 161₄, only the ‘STOCK AND INDUSTRY’ tab, which is selected by using the menu contents screen 16A, is reversing displayed. The call buttons 162₁, 162₂, . . . 162_{N}, the number of which is equal to the number of topic information 252 related to the index data 25, are displayed in a vertical line on the call button display area 162. The call buttons 162₁, 162₂, . . . 162_{N} are arranged in the same order as the topic information. Each of the call buttons 162₁, 162₂, . . . 162_{N} is individually related to one of the topic information 252. Each of the topic information 252 is displayed as a text information, for example, ‘General’, ‘First Section of Tokyo Stock Exchange’, ‘Second Section of Tokyo Stock Exchange’, etc.

Additionally, the graph display unit 211 displays the first to fourth graphs 253₁ₐ to 253₄ₐ related to the call button displayed at the top of the call button display area 162 (i.e. related to the first topic information 252) on the graph display area 163. Concretely, the first graph 253₁ₐ is displayed on the first graph display area 161₁, the second graph 253₂ₐ is displayed on the second graph display area 161₂, the third graph 253₃ₐ is displayed on the third graph display area 161₃, the fourth graph 253₄ₐ is displayed on the fourth graph display area 161₄. Furthermore, the graph titles 254₁, 254₂, 254₃ and 254₄ are displayed.

Next, the graph display unit 211 sets the call button hold flag and the simple explanation reading flag, both of which are located in the memory of the client terminal 1, to ‘False’ (see step S25). The call button hold flag is used for making the displaying of the graph 253ₐ to be continued. The simple explanation reading flag is used for controlling the pop-up displaying on the graph 253ₐ. The ‘false’ means that the corresponding processing is not performed.

### <First Processing of Mouse Cursor on the Call Button>

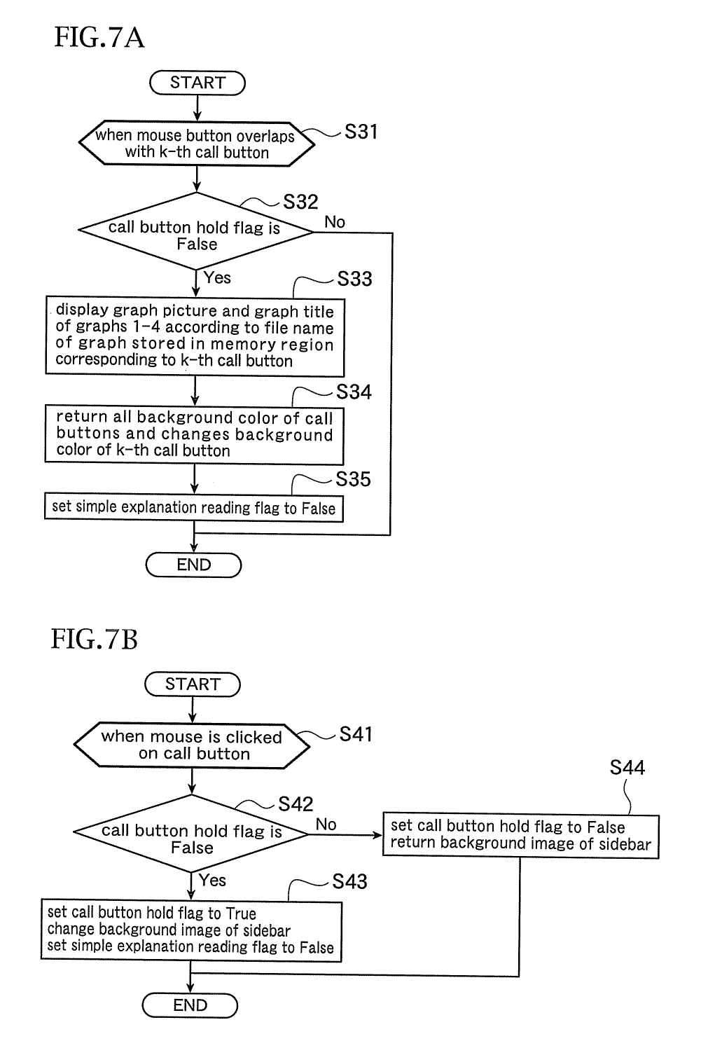

FIG. 7A is a flowchart showing procedures when a mouse cursor 121 moves on the call buttons 162₁, 162₂, . . . 162_{N} displayed on the selected category screen 16B.

FIG. 7A shows the state that the mouse cursor 121 is overlapped with the k-th call button (for example, the eighth call button 162₈ from the top) among the call buttons 162₁, 162₂, . . . 162_{N} under the operation of the operation unit 12 in the client terminal 1 (see step S31). The state that the mouse cursor 121 is overlapped with one of the call button is simply called ‘mouse over’ in the present specification. In such case, the graph display switch unit 212 replaces the graph displayed on the graph display area 163 with the graph corresponding to the call button 162₈ being overlapped with the mouse cursor 121.

Concretely, in the case where the call button hold flag located in the memory of the client terminal 1 is set to ‘false’ (this case corresponds to ‘Yes’ of the step S32), the graph display switch unit 212 acquires the data of the corresponding first graph 253₁ₐ, the corresponding second graph 253₂ₐ, the corresponding third graph 253₃ₐ and the corresponding fourth graph 253₄ₐ from the indexed contents storage unit 222, by using the first file name information 253_{1b} through the fourth file name information 253_{4b} stored in the memory's row related to the call button performing the ‘mouse over’ by the mouse cursor 121, that is, the eighth call button 162₈ from the top. Moreover, the graph display switch unit 212 makes the first through fourth graph display areas 161₁ through 161₄ to display the acquired first through fourth graphs 253₁ₐ-253₄ₐ, instead of the first through fourth graphs 253₁ₐ-253₄ₐ displayed until then (see step S33). Furthermore, the graph display switch unit 212 makes the first through fourth graph display areas 161₁ through 161₄ to display the graph titles 254₁, 254₂, 254₃ and 254₄ stored in the memory's row corresponding to the eighth call button 162₈ from the top (see step S33).

Then, the graph display unit 211 makes the background colors of all call buttons 162₁ through 162_{N} to be returned (see step S34). As a result, the coloration of the first (i.e. top) call button 162₁, in which the background color has been reversed, returns to the original state. Additionally, the graph display unit 211 makes the call button 162₈, which is the eighth button from the top and is selected by ‘mouse over’ by the mouse cursor 121, to be reversing displayed (see step S34). Moreover, the graph display unit 211 sets the simple explanation reading flag, which is located in the memory, to ‘False’ (see step S35).

Incidentally, in the case where the call button hold flag is not set to ‘False’, the process after step S33 are not performed even if the mouse cursor 121 overlaps with the call button 162₈ (this case corresponds to ‘No’ of the step S32).

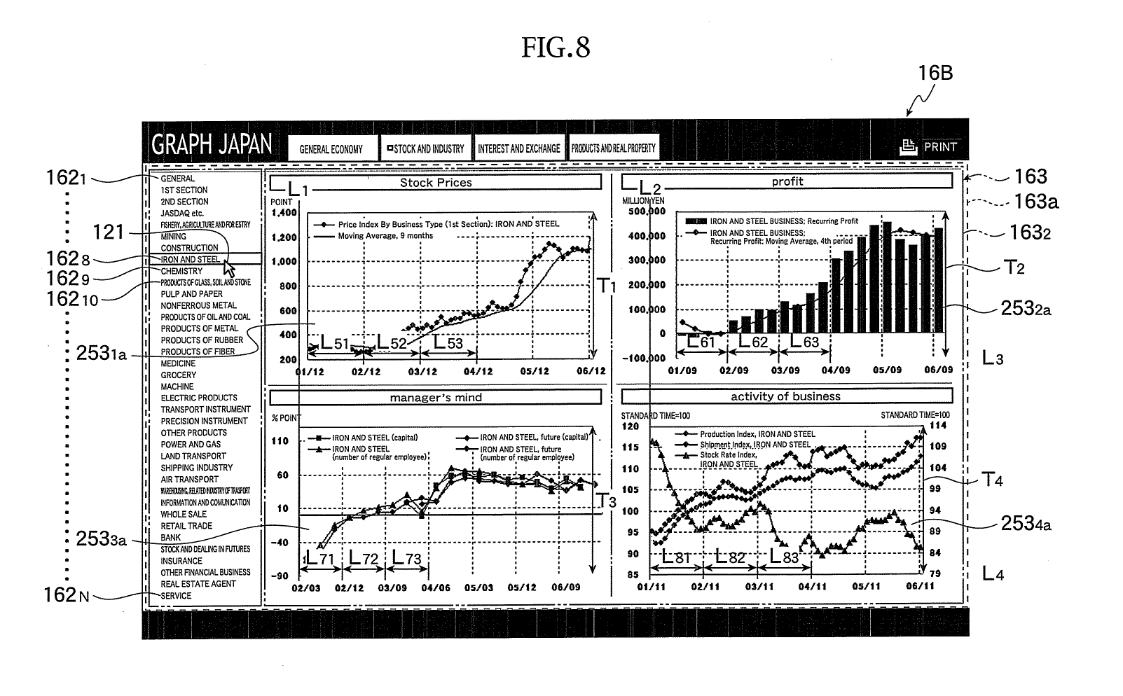

By performing the procedures described above, the screen 16B corresponding to the selected category, which is shown in FIG. 8, is generated and displayed on the Web browser 131. As shown in FIG. 8, the eighth call button from the top, that is the call button 162₈, is selected by ‘mouse over’ by the mouse cursor 121 and the coloration of it is reversed. In addition, the graphs 253ₐ belonging to the topic ‘IRON AND STEEL’ corresponding to the call button 162₈ are displayed on the graph display area 163.

In such condition, when the mouse cursor 121 moves while performing ‘mouse over’ through the ninth call button 162₉, the tenth call button 162₁₀, etc., the targeted call button for ‘mouse over’ is switched continuously based on the movement of the mouse cursor 121, and so the processing from step S31 to S35 are repeated. Therefore, the passage of the mouse cursor 121 while performing ‘mouse over’ toward the call buttons 162₉, 162₁₀, etc. causes the switching of the call button of reversed displaying. Furthermore, because of the movement, the graph 253ₐ displayed on the graph display area 163 is switched quickly and continuously to the graph 253ₐ corresponding to the topic (i.e. the topic information 252) displayed on the call button 162₉, 162₁₀, etc., that is, the graph 253ₐ corresponding to the topic information 252 of the call button 162₉, 162₁₀, etc. selected by ‘mouse over’ by the mouse cursor 121. As a result, the graph 253ₐ displayed on the web browser 131 of the display unit 13 in the client terminal 1 can be switched quickly and continuously.

Incidentally, as shown in FIGS. 6 and 8, whenever the graph display unit 211 displays the graph display area 163 related to one of the topics of the screen 16B corresponding to the selected category, each of the first graphs 253₁ₐ, each of the second graphs 253₂ₐ, each of the third graphs 253₃ₐ and each of the fourth graphs 253₄ₐ are respectively displayed so that the positions of the vertical axis, the positions of the horizontal axis, the sizes toward the vertical direction, the sizes toward the horizontal direction and the scales are the same between the corresponding graphs of each category.

For example, the Y-axis of the first graph 253₁ₐ of the first graph display area 161₁ and the third graph 253₃ₐ of the third graph display area 161₃ are respectively set on the line L₁ at both of the FIGS. 6 and 8. Similarly, the Y-axis of the second graph 253₂ₐ of the second graph display area 161₂ and the fourth graph 253₄ₐ of the fourth graph display area 161₄ are respectively set on the line L₂ at both of the FIGS. 6 and 8.

Moreover, the X-axis of the first graph 253₁ₐ of the first graph display area 161₁ and the second graph 253₂ₐ of the second graph display area 161₂ are respectively set on the line L₃ at both of the FIGS. 6 and 8. Similarly, the X-axis of the third graph 253₃ₐ of the third graph display area 161₃ and the fourth graph 253₄ₐ of the fourth graph display area 161₄ are respectively set on the line L₄ at both of the FIGS. 6 and 8.

As a result, when the screens shown in FIGS. 6 and 8 are switched for comparison, the positions are the same between the first graphs 253₁ₐ of both screens, the second graphs 253₂ₐ of both screens, the third graphs 253₃ₐ of both screens and the fourth graphs 253₄ₐ of both screens, concerning both of the X-axis direction and Y-axis direction. Therefore, the comparisons between the graphs 253ₐ displayed at the same locations of FIGS. 6 and 8 become easier.

In addition, the X-axis scale intervals L₅₁, L₅₂, L₅₃, . . . are the same between the first graphs 253₁, on the first graph display area 161₁ of FIGS. 6 and 8, the X-axis scale intervals L₆₁, L₆₂, L₆₃, . . . are the same between the second graphs 253₂ₐ on the second graph display area 161₂ of FIGS. 6 and 8, the X-axis scale intervals L₇₁, L₇₂, L₇₃, . . . are the same between the third graphs 253₃ₐ on the third graph display area 163₃ of FIGS. 6 and 8 and the X-axis scale intervals L₈₁, L₈₂, L₈₃, . . . are the same between the fourth graphs 253₄ₐ on the fourth graph display area 161₄ of FIGS. 6 and 8. In other words, the scales of time direction are the same between the graphs 253ₐ displayed on the same location.

As a result, the comparison between the graphs 253ₐ displayed at the same location of FIGS. 6 and 8 become easier.

Moreover, the plot area's height T₁ are the same between the first graphs 253₁ₐ on the first graph display area 161₁ of FIGS. 6 and 8, the plot area's height T₂ are the same between the second graphs 253₂ₐ on the second graph display area 161₂ of FIGS. 6 and 8, the plot area's height T₃ are the same between the third graphs 253₃ₐ on the third graph display area 161₃ of FIGS. 6 and 8, the plot area's height T₄ are the same between the fourth graphs 253₄ₐ on the fourth graph display area 161₄ of FIGS. 6 and 8. In other words, the sizes of height direction are the same between the graphs 253ₐ displayed on the same location.

As a result, the comparison between the graphs 253ₐ displayed at the same location of FIGS. 6 and 8 become easier.

### <Second Processing of the Mouse Cursor on the Call Button>

FIG. 7B is a flowchart showing procedures when the call buttons 162₁, 162₂, . . . 162_{N} displayed on the screen 16B of the selected category are clicked by using the cursor 121. As shown in the FIG. 7B, under the operation of the operation unit 12 in the client terminal 1, the mouse cursor 121 clicks the k-th call button (for example, the call button 162₈ which is the eighth call button from the top, under the state shown in FIG. 8) among the call buttons 162₁, 162₂, . . . 162_{N}(see step S41). In such case, the graph display unit 211 continues the displaying of the graph being displayed on the graph display area 163 at that time. Concretely, in the case where the call button hold flag is set to ‘False’ (this case corresponds to ‘Yes’ of the step S42), the graph display unit 211 sets the call button hold flag to ‘True’, changes the displaying condition of the call button display area 162 to the condition that the displaying of the clicked call button 162₈ is kept to be reversed, and sets the simple explanation reading flag to ‘False’ (see step S43).

Incidentally, in the case where the call button hold flag is not set to ‘False’ (this case corresponds to ‘No’ of the step S42), the graph display unit 211 sets the call button hold flag to ‘False’, and changes the displaying condition of the call button display area 162 to the condition that the reversed displaying of the specified call button (for example, the call button 162₂) is canceled (see step S44).

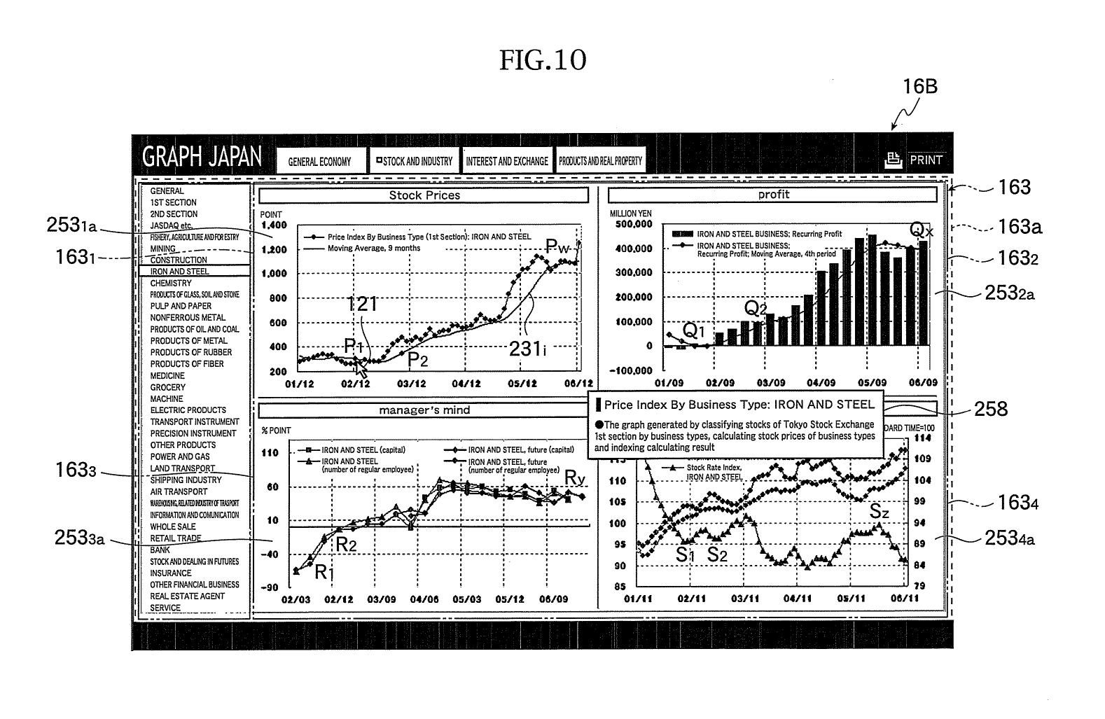

By performing the procedures described above, it become possible that the graph 253ₐ displayed on the graph display area 163 is not changed, that is, identical graph 253ₐ is kept to be displayed on the graph display area 163, even if the mouse cursor 121 leaves from the eighth call button 162₈, as shown in FIG. 10 for example.

### <First Processing of the Mouse Cursor on the Graph>

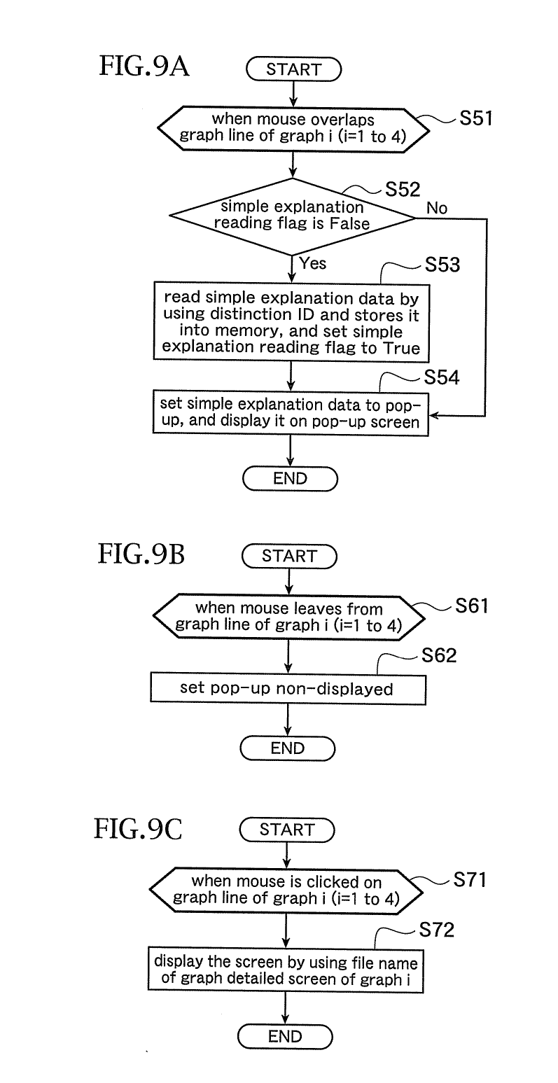

FIG. 9A is a flowchart showing the procedures for displaying the simple explanation information 258 on the graph display area 163. As shown in FIG. 9A, when the ‘mouse over’ by the mouse cursor 121 toward one of the point P (or point Q, point R, point S) on the graph (i.e. a line graph, a bar chart etc.) is executed by the user's operation of the operation unit 12 provided in the client terminal 1 (see step S51), the graph display unit 211 displays the simple explanation information 258 related to the point P (or point Q, point R, point S) with using a pop-up screen. Concretely, when the ‘mouse over’ is performed toward one of the points, for example point P₁, on the graph 253i (‘i’ is one of 1 through 4) displayed on the first to fourth graph display area 161₁ through 161₄ as shown in FIG. 10 (in this case, the graph 253i is corresponding to the graph displayed on the first graph display area 161₁), the graph display unit 211 checks whether the simple explanation reading flag, which is located in the memory (i.e. RAM) provided in the client terminal 1, is ‘False’. In the case where the simple explanation reading flag is ‘False’ (this case corresponds to ‘Yes’ of the step S52), the graph display unit 211 reads the file data 258a of the corresponding simple explanation information 258 from the indexed contents storage unit 222 based on the ID information 256 and the file name information 258b in the simple explanation information 258 related to the point P₁ to which the ‘mouse over’ by the mouse cursor 121 is performed. Next, the graph display unit 211 stores the read file data 258a into the memory of the client terminal 1. In the present embodiment, not only the file data 258a in connection with the point to which the ‘mouse over’ is performed, but also all file data 258a of all simple explanation information 258 in connection with all other points of the graph data 253 (i.e., points P₂, . . . P_{W} in this case) are stored into the memory of the client terminal 1 by the graph display unit 211.

Then, the graph display unit 211 sets the simple explanation reading flag to ‘True’ (see step S53). Furthermore, the graph display unit 211 sets the simple explanation information 258 to ‘pop-up’, and makes it to be displayed on the graph display area 163 with using a pop-up screen (see step S54).

Incidentally, in the case where the point P₁'s simple explanation reading flag stored in the client memory 1 is not set to ‘False’ (this case corresponds to ‘No’ of the step S52), the graph display unit 211 sets the point P₁'s simple explanation information 258 to ‘pop-up’ without performing the procedure of the step S53, and makes it to be displayed on the graph display area 163 with using a pop-up screen (see step S54).

FIG. 10 is a conceptual diagram showing the graph display area 163 of the Web browser 131 on which the simple explanation information 258 is displayed. As shown in FIG. 10, the graph display area 163 displays the text information corresponding to the simple explanation information 258 of the point P₁ to which the ‘mouse over’ is performed by the mouse cursor 121.

Incidentally, when the ‘mouse over’ by the mouse cursor 121 is performed toward other points P₂, . . . P_{W} on the first graph 253₁ₐ, the points Q on the second graph 253₂ₐ, the points R on the third graph 253₃ₐ or the points S on the fourth graph 253₄ₐ, the procedures from the step S51 to the step S54 are executed and the simple explanation information 258 is displayed by using a pop-up screen.

### <Second Processing of Mouse Cursor on the Graph>

FIG. 9B is the flowchart showing the procedures of processing when the mouse cursor 121 leaves from one of the points P, for example the point P₁, under the situation that the simple explanation information 258 is displayed on the graph display area 163. As shown in the step 854 of FIG. 9B, after the mouse cursor 121 leaves from the point P, for example the point P₁, to which the ‘mouse over’ is performed (see step S61), the graph display unit 211 makes the simple explanation information 258 to be non-displayed (see step S62).

In other words, after the ‘mouse over’ by the mouse cursor 121 toward the point P₁ is performed as shown in FIG. 10, the mouse cursor 121 leaves from the point P₁, then, the simple explanation information 258 shown in FIG. 10 becomes non-displayed.

As a result, the displayed simple explanation information 258 related to the graph 253ₐ is switched quickly and continuously with following the movement of the mouse cursor 121 on the graph 253ₐ, because the processing from the step S51 to S54 executes the pop-up displaying of the simple explanation information 258 related to the point P, Q, R or S to which the mouse cursor performs the ‘mouse over’ and the processing of the step S61 and S62 erases the pop-up displaying of the simple explanation information 258. Therefore, the simple explanation information 258 displayed on the web browser 131 of the display unit 13 provided in the client terminal 1 can be switched quickly and continuously.

### <Third Processing of Mouse Cursor on the Graph>

FIG. 9C is a flowchart showing the procedures when one of the points P plotted on the graph 253ₐ (for example, on the line of the line graph, on the bar of the bar chart, etc.) displayed on the graph display area 163 is clicked.

As shown in FIG. 9C, when the mouse cursor 121 is moved to one of the points P, (or one of the points Q, R or S) plotted on the graph (for example, on the line of the line graph, on the bar of the bar chart, etc.) and the mouse is clicked under the operation of the operating unit 12 provided in the client terminal 1, the detailed information display unit 216 makes the detailed information 257 related to the clicked point belonging to the points P (or points Q, R or S) to be displayed on the web browser 131. Concretely, when one of the points P, for example the point P₁, plotted on the line of the graph 253i (‘i’ is one of 1 through 4, the graph 253i is the graph of the first graph display area 161₁ in this explanation) displayed on one of the first graph display area 161₁ to the fourth graph display area 161₄, is clicked (see step S71), the detailed information display unit 216 acquires the file data 257a related to the point P₁ from the indexed contents storage unit 222 based on the ID information 256 and the file name information 257b of clicked point P₁, and makes the file data 257a to be displayed as the detailed information 257 (see step S72).

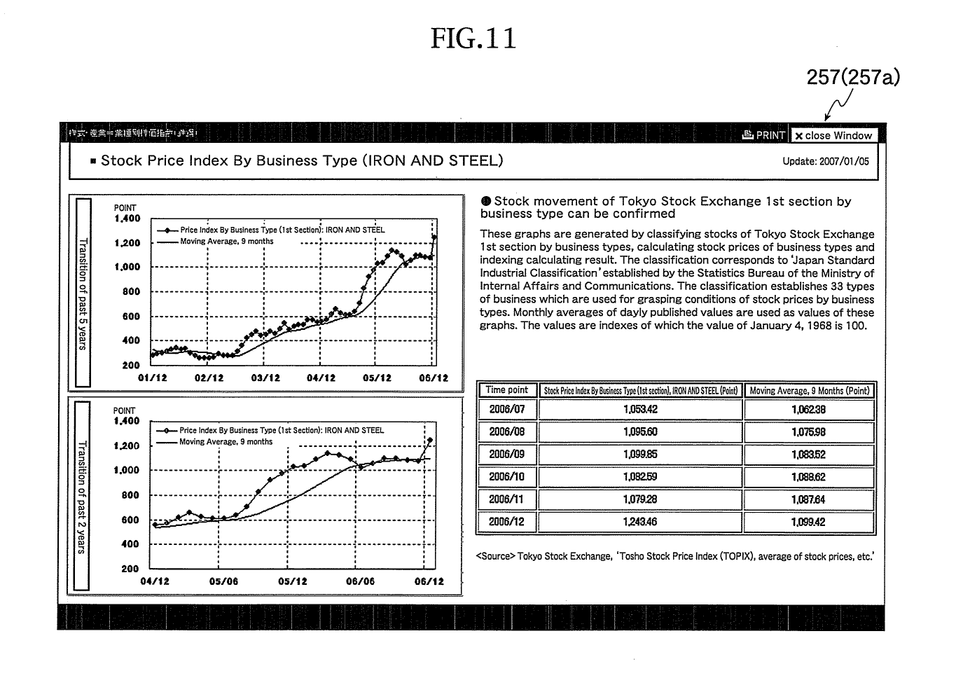

FIG. 11 is a conceptual diagram showing the detailed information 257 displayed on the Web browser 131. As sown in FIG. 11, the detailed information 257 contains the text information for minutely explaining about the point P₁ plotted on the line of graph 253i displayed on the first graph display area 161₁. The investors etc. using the client terminal 1 can deeply understand and accurately perform the decision about the investment by using the detailed information 257.

Incidentally, the procedures of the step S71 and S72 are processed and the detailed information 257 related to one of the points P₂, . . . P_{W}, Q, R or S is displayed when one of other points P₂, . . . P_{W} on the first graph 253₁, one of the points Q displayed on the second graph 253₂, one of the points R, displayed on the third graph 253₃ or one of the points S displayed on the fourth graph 253₄ is clicked.

As described above, the present embodiment can supply the economic statistical data to the client terminal 1 as graph information easy to understand visually, because the graph display device 2 comprises the indexed contents storage unit 222 which stores the graphs 253ₐ generated corresponding to the economic statistical data and the attribute information of the graph 253ₐ. Moreover, the present embodiment can make the client terminal 1 to display the graphs based on the economic statistical data, because the present embodiment comprises the graph display unit 211 that displays the graph 253ₐ stored in the indexed contents storage unit 222 on the graph display area 163 provided in the display unit 13. Furthermore, the present invention can quickly and appropriately select the user's desired graph 253ₐ from plural of the graphs, and display it, because the display unit 13 of the client terminal 1 displays plural of the call button display areas 162 in the state arranged in a line, the call button display area 162 displays the call buttons 162₁, 162₂, . . . 162_{N} which are related to the graph 253ₐ being able to displayed on the graph display area 163 and are used for displaying them, and the graph display switch unit 213 switches the graph 253ₐ displayed on the graph display area 163 to the graph 253a related to the call buttons 162₁, 162₂, . . . 162_{N} corresponding to the input call instruction. Additionally, the present embodiment can easily execute the comparison of plural graphs because the switched graphs 253ₐ are displayed in the same specified area on the graph display area 163. Moreover, the present embodiment can display the graphs easy to view on the display unit even if the number of the compared graphs 253ₐ is large, because only the necessary graphs 253ₐ can be selected from the plural graphs 253ₐ and can be displayed on the graph display area 163. As a result, the present embodiment can display the graphs, which are generated from the economic statistical data, at the state easy to view, easy to compare appropriately, and easy and quickly to display.

According to the present embodiment, the indexed contents storage unit 222 stores the topic information 252, which are generated according to the kind etc. of the information corresponding to the graph 253ₐ etc., as an attribute information of the graph 253ₐ. In addition, the call button display unit 212 makes the call button display area 162 to display the topic information 252 related to the individual graphs 253ₐ on the corresponding call button 162₁, 162₂, . . . 162_{N}. The graph display switch unit 213 switches the displayed graph 253a on the graph display area 163 to the graph 253ₐ related to the attribute information of the instructed call buttons 162₁, 162₂, . . . 162_{N}. As a result, the call button 162₁, 162₂, . . . 162_{N} can display the topic information 252 which are closely related to the meanings and contents of the graphs 253ₐ, and so the investors using the client terminal 1 can make the graph display area 163 to display the desired graph 253ₐ while viewing the displayed topic information 252.

The graph display unit 211 of the present embodiment can continue the displaying of the graph 253ₐ, when it is necessary to be displayed in long time. That is because the graph display unit 211 continues the displaying of the graphs 253ₐ, when it inputs the command to keep the display of graphs from the operation unit 12 of the client terminal 1.

The graph display unit 211 of the present embodiment can display the first graph 253₁ₐ, the second graph 253₂ₐ, the third graph 253₃ₐ and the fourth graph 253₄ₐ on the graph display area 163 at the same time, in other words, the graph display unit 211 can make the graph display area 163 to display the graphs 253₁ₐ to 253₄ₐ closely related to each other at the same time. Therefore, the present embodiment can makes it easier to compare the graphs 253₁ₐ to 253₄ₐ, which are closely related to each other

According to the present embodiment, the graph display unit 211 generates the graphs 253ₐ, in which the horizontal axis is the time axis, and makes the graph display area 163 to display graphs in which each of the graphs displayed at the same position has the horizontal axis of substantially the same coordinate and substantially the same position. As a result, the present embodiment can make the coordinate and displayed position of the time axis substantially the same between all of the corresponding graphs of the time series economic statistical data. Therefore, it is easy for the users to compare the information of the graphs 253ₐ visually, because all time information of the graphs 253ₐ are unified. Consequently, the present embodiment can makes it easier to compare the graphs 253ₐ in a visual and feeling manner.

According to the present embodiment, the graph display unit 211 makes the graph display area 163 to display graphs in which each of the graphs displayed at the same position has the vertical axis of substantially the same position and substantially the same length. As a result, the present embodiment can make the height of the graphs 253ₐ substantially the same between all graphs of the same position. Consequently, the present embodiment can makes it easier to compare the graphs 253ₐ in a visual and feeling manner.

According to the present embodiment, the indexed contents storage unit 222 stores the category information 251, each of which relates to plural units of topic information 252 containing the graphs 253ₐ and attribute information. Moreover, the present embodiment comprises the category information display unit 214 making the Web browser 131, which is provided in the display unit 13 in the client terminal 1, to display the category display area containing the graph display area 163 and the call button display area 162. Furthermore, the present embodiment comprises the category display switch unit 215 for switching the category information 251 displayed on the category display area 163a to the instructed category information 251 based on the instruction, which is input from the operation unit 12 in the client terminal 1, to display the specified category information. Consequently, the present embodiment can make the client terminal 1 to display the graphs 253ₐ under the state that the graphs 253ₐ are divided into groups based on meanings and contents of the graphs 253ₐ. The investors etc. can search their desired information by using the category information 251 that is closely related to the meanings and contents of the graph 253ₐ. As a result, the users can select the graphs more quickly and easily, can put the complex economic statistical data in order by categories and topics of the financial products, can easily acquire the information necessary for making decision about investment, and can decide appropriately.

The present embodiment comprises the detailed information display unit 216 that makes the display unit 13 of the client terminal 1 to display the detailed information 257 which are related to the graphs 253ₐ and indicate the detailed information of the graphs 253ₐ stored in the indexed contents storage unit 222. Therefore, the investors etc. can grasp the detail of information of the graphs 253ₐ and related information easily, and so the investors etc. can decide whether investment should be executed or not.

As described above, the graph display device 2 is constituted as a server device of a client server type computer system. However, the graph display device 2 can be constituted as a stand-alone type computer.

The above described embodiment is merely one embodiment of the present invention, and it is obvious that the present invention does not limited to this embodiment.

### DESCRIPTION OF THE REFERENCE SYMBOLS

1, 1₁, 1₂, . . . 1ₙ: client terminal
2: graph display device
12: operation unit (operation means)
13: display unit (display means)
121: mouse cursor (operation means)
162: call button display area (topic display area)
162₁, 162₂, . . . 162ₖ, 162_{N}: call button
211: graph display unit (graph display means)
212: call button display unit (call button display means)
213: graph display switch unit (graph display switch means)
214: category information display unit (category information display means)
215: category display switch unit (category display switch means)
216: detailed information display unit (detailed information display means)
222: indexed contents storage unit (storage means)
251: category information
252: topic information
253ₐ, 253₁ₐ, 253₂ₐ, 253₃ₐ, 253₄ₐ, 253i: graph
257, 257a: detailed information
258, 258a: simple explanation information

1-10. (canceled)

11. A graph display system comprising:
an indexed contents storage memory which stores graphs by topic information,
a display device which displays a graph display area to display the graph corresponding to one of the topic information, and a call button display area to simultaneously display call buttons in order, each call button corresponds to one of the topic information,
a graph display controller which makes the graph corresponding to the operated call button to be displayed on the graph display area, when one of the call buttons displayed on the call button display area is operated by a user,
a graph display switching controller which switches the displayed graph of the graph display area to the graph corresponding to the operated call button, such that the newly displayed graph has the same sizes, the same scale intervals and the same displayed position as the previously displayed graph, when one of other call buttons is operated by the user.

12. The graph display system according to claim 11, wherein:
when a call button hold flag is ‘true’, the graph display switching controller switches the graph displaying following to the operation, and
when a call button hold flag is ‘false’, the graph display switching controller does not switch the graph displaying even if the operation is executed.

13. The graph display system according to claim 11, wherein:
the indexed contents storage memory stores plural kinds of graphs by the topic information, and
the graph display switching controller switches the displayed graph of the graph display area to other graphs corresponding to one of other topic information, such that newly displayed graphs have the same sizes, the same scale intervals and the same displayed position as corresponding previously displayed graphs.

14. The graph display system according to claim 11, wherein the operation by the user is the operation for making the mouse cursor to be positioned on the call button.

15. The graph display system according to claim 11, wherein the operation to one of other call buttons is the operation for making the mouse cursor to be moved from the call button corresponding to the presently displayed graph to the other call button.

16. The graph display system according to claim 11, wherein:
the topic information is classified into categories and stored into the indexed contents storage memory, and
the display device displays the graph display area and the call button display area corresponding to the category selected by the user's operation.

17. The graph display system according to claim 11, comprising:
a server system which has the indexed contents storage memory, the graph display controller and the graph display switching controller,
one or more client terminals which has the display device,
a communication network which connects the server system and the client terminals.

18. The graph display system according to claim 11, wherein the indexed contents storage memory stores one or more explanation information corresponding to each of the graphs.

19. A computer-readable storage medium having recorded thereon a computer program for causing a computer to work as a graph display system, the computer program implements:
a first step of displaying a graph display area to display the graph corresponding to one of topic information, on a display screen,
a second step of displaying a call button display area to simultaneously display call buttons in order, each of the call buttons corresponds to one of the topic information,
a third step of making the graph corresponding to the operated call button to be displayed on the graph display area, when one of the call buttons displayed on the call button display area is operated by a user,
a fourth step of switching the displayed graph of the graph display area to the graphs corresponding to the operated call button, such that the newly displayed graph has the same sizes, the same scale intervals and the same displayed position as the previously displayed graph, when one of other call buttons is operated by the user.

20. The computer-readable storage medium according to claim 19, wherein:
when a call button hold flag is ‘true’, the fourth step switches the graph displaying following to the operation, and
when a call button hold flag is ‘false’, the fourth step does not switch the graph displaying even if the operation is executed.

21. The computer-readable storage medium according to claim 19, wherein:
the graph display area displays plural kinds of graphs by the topic information, and
the fourth step switches the displayed graphs of the graph display area to other graphs corresponding to one of other topic information, such that newly displayed graphs have the same sizes, the same scale intervals and the same displayed position as corresponding previously displayed graphs.

22. The computer-readable storage medium according to claim 19, wherein the operation by the user is the operation for making the mouse cursor to be positioned on the call button.

23. The computer-readable storage medium according to claim 19, wherein the operation to one of other call buttons is the operation for making the mouse cursor to be moved from the call button corresponding to the presently displayed graph to the other call button.

24. The graph display system according to claim 1, wherein:
the topic information is classified into categories and;
the graph display area and the call button display area corresponding to the category selected by user's operation is displayed on the display screen.

25. The computer-readable storage medium according to claim 19, wherein one or more explanation information corresponding to each of the graphs are displayed based on the user's operation.
